(19) United States
(12) Patent Application Publication
(10) Pub. No.: US 2019/0124938 A1
(43) Pub. Date: May 2, 2019

(54) A METHOD FOR COOLING AND STORING FOOD ITEMS

(71) Applicant: SKAGINN HF, Akranes (IS)

(72) Inventor: Ingolfur ARNASON, Akranes (IS)

(21) Appl. No.: 16/096,003

(22) PCT Filed: Apr. 26, 2017
(86) PCT No.: PCT/IS2017/050006

§ 371 Date: Oct. 24, 2018

(30) Foreign Application Priority Data
Apr. 26, 2016 (IS) 050147

(51) Int. Cl. A23B 4/08; F25D 3/08

(52) U.S. Cl. CPC A23B 4/08; F25D 3/08

(57) ABSTRACT

The invention provides a method for cooling, transporting and storing wet food product without using ice for the transport and the storage using a new method of cooling the food products below zero to prolong shelf-life and quality of the product. Furthermore, the present invention provides a new method for delivering a fresh food product to the market with reduced water footprint and carbon footprint.

### FIELD OF THE INVENTION

The invention provides a method for cooling, transporting and storing wet food product using little or no ice for the transport and the storage. Furthermore, the present invention provides a new method for delivering a fresh food product to the market with reduced water footprint and carbon footprint.

### BACKGROUND

The time period from when a caught fish ends up on the deck of a fishing ship and to the time the fish has been processed and is ready for packing or the market can vary depending on where the processing is performed. In many cases the processing is done on land, which requires storing the fish at sea and during transport to the factory. All handling and transport has effect on the quality of the fish, especially on soft and fragile fish. Currently, slaughtered salmon is chilled or frozen on ice in Styrofoam boxes on ice. The ice does damage to the surface of the fish and the ice needs to be melted and dealt with in an environmentally friendly manner and the boxes need to be washed and transported back or destroyed. This is both costly and time consuming.

The demand for more environmental friendly processes in the food industry is growing. The transport of food by ships, trucks and airplanes results in an enormous amount of greenhouse gas emissions associated with the burning of fossil fuels. The food industry is also very water consuming both in processing steps and the use of ice for transport of fresh food. As an example, 240.000 mT of salmon are now transported to Asia in airplanes. That means 48.000 mT of ice is also transported to Asia. 48.000 mT is equal to more than 1.000 jumbo jets filled with ice. The term “carbon footprint” is a definition of the total set of greenhouse gas emissions caused by bringing a product to the market and the term “water footprint” is defined as the total volume of freshwater used to bring a product to the market. There is therefore a growing need for methods of production and transportation in the food industry where greenhouse gas emissions and the use of freshwater is decreased.

WO 2014/174535 discloses a method for processing undercooled fish, chilled by super-chilling using a saline solution and slurry ice to bring the fish to an undercooled state and processing the fish after being brought to an undercooled state. This technology has the drawback that the temperature of the slurry is at the freezing point of the slurry solution determined by the salt concentration and the temperature of the surface and the inside of the fish will not be the same. Furthermore, the temperature of the slurry solution being at its freezing point will result in the surface of the fish to freeze and/or create form an ice shell.

### SUMMARY OF THE INVENTION

It is an object of the present invention to overcome or ameliorate the aforementioned drawbacks of the prior art and to provide an improved and/or alternative and/or additional method for cooling and storing and/or transporting wet food product using little or no ice comprising undercooling the product by submerging in salt solution at a sub-zero temperature at or above the freezing point of the solution while the solution is agitated in order to prevent formation of ice shell or crust on the product. It is one preferred object of the present invention to provide a method of storing the product in the storing receptacle within a space which is maintained at a temperature within the range of about −4° to 0° C., where the food product has been brought to an undercooled state using a salt- and temperature controlled solution. Moreover, it is a preferred object of the present invention to provide a method, preferably designed to transport wet food products in an ice reduced or ice-free manner where the product is transported in an ice reduced or ice-free manner in order to save use of freshwater and to reduce damage of the wet food products due to the ice. The solution of the present invention further gives the producer the opportunity to carbon offset based on the reduced amount of greenhouse gas emissions in the processing and transport of the food product.

The object(s) underlying the present invention is (are) particularly solved by the features defined in the independent claims. The dependent claims relate to preferred embodiments of the present invention. Further additional and/or alternative aspects are discussed below.

Thus, at least one of the preferred objects of the present invention is solved by a method for cooling and storing and/or transporting wet food product. It is one preferred object of the present invention to provide a method comprising the steps of i) undercooling the product by submerging in salt solution at a sub-zero temperature at or above the freezing point of the solution, while the solution is agitated in order to prevent formation of ice shell or crust on the product, ii) removing the product from the solution and placing in a storing receptacle, and iii) storing the product in the storing receptacle within a space which is maintained at a temperature within the range of about −4° to 0° C.

The present invention provides a new method. The method of the present invention provides a way to store and transport fresh food, such as freshly caught and slaughtered fish in an ice-free or ice reduced manner. The method requires cooling the food product by a cooling process resulting in under-cooling of whole wet food product directly after it has been slaughtered and bringing it to an under-cooled state in a salt-controlled and temperature-controlled solution, where a salt concentration is chosen which determines a freezing point of the solution and the temperature of the solution is maintained or manually set substantially constant at a temperature which is higher than the freezing point of the solution. The new method provides conditions where the temperature at the surface of the wet food product and the inside of the meat is substantially the same. By using the present method, the salt concentration and temperature of the solution provides conditions at the surface of the wet food product preventing any shell or crust formation at the surface allowing more effective heat transfer and thus more effective cooling of the flesh/fish/meat to bring the wet food product to a desired temperature. In order to further prevent shell or crust formation at the surface of the wet food product during the cooling process, a movement of the food product is maintained in the solution during the under-cooling process. In one preferred embodiment of the invention the ratio of solution and food product in the cooling device or tank is kept such that the salt-controlled and temperature-controlled solution constitutes at least 50% of the filled volume (food product and solution) in in the container.

The present invention provides a new and improved method of storing and/or transporting wet food products in an ice-free or ice reduced manner. In some embodiments of the present invention, the following features may be employed: a) using a salt-controlled and temperature-controlled solution at a set temperature and a salt concentration to set the freezing point of the solution below the set temperature of the solution, such that the salt melts any formation of a shell or crust at the surface of the wet food product, and thereby bringing the wet food product to a desired temperature at or near the phase transition of freezing without freezing the wet food product, b) moving the wet food product around in the solution during the undercooling process to prevent the food product from freezing or hardening, c) keeping the volume of fluid above 50% with respect to total volume of wet food product and fluid and d) storing the wet food product at the desired temperature at or near the phase transition of freezing the wet food product without freezing it, providing a solution for storing and transporting freshly slaughtered animals or food products in an ice-free or ice reduced environment saving water and space in transport packaging. One of the advantages of storing and/or transporting wet food products such as fish using the method of the present invention for two days or more is that this results in detachment of the flesh from the bones.

There are a number of benefits by storing and transporting freshly slaughtered animals or food products in an ice-free or ice reduced environment apart from increased quality of the food product. Benefits relating to reduced emissions of greenhouse gases are factors such as reduced packing costs, as ice takes up a considerable amount of volume, lighter transport weight, no energy is used to produce ice, reduced transportation costs as more food product can be transported per packing and cooler product at the end of transport does not require additional cooling before further processing. Furthermore, the food product can be stored and transported in bigger containers or boxes made from thinner material (not Styrofoam boxes) such as cardboard boxes with or without plastic coating, reduced transport weight. Benefits relating to reduced use of fresh water are factors such as seawater can be used as a base for the salt solution used to undercool the food product (especially for fish) and ice disposal is not required (often requires crushing and thawing the ice and then filtering the melted ice to remove organic material).

The invention further provides a method of reducing the environmental footprint comprising a water footprint and a carbon footprint of a food product. The method comprises a) undercooling the product by submerging in salt solution at a sub-zero temperature at or above the freezing point of the solution, while the solution is agitated in order to prevent formation of ice shell or crust on the product, b) removing the product from the solution and placing in a ice-free or ice reduced package while maintaining the temperature of the product, c) storing the product in the ice-free or ice reduced package within a space which is maintained at a temperature within the range of about −4° to 0° C., and d) transporting the product in the ice-free or ice reduced package within a space which is maintained at a temperature within the range of about −4° to 0° C.

In one embodiment method of cooling and storing and/or transporting wet food product comprises undercooling the product in a solution being agitated in order to prevent formation of ice shell or crust on the product in at least two steps of:
i) placing the food product in first salt-controlled and temperature controlled solution having a salt concentration in the range of 0.1-10% and a temperature within the range of +1 to −3° C., and preferably in the range from −0.5 to −3° C. where the salt concentration and set temperatures of the salt-controlled and temperature controlled solution brings the homogenous temperature of the food product to a temperature in the range from +2 to −1° C., and more preferably to a temperature in the range from 0 to −1° C.
ii) transferring the food product to a second salt-controlled and temperature controlled solution having a salt concentration of 1-20% and a temperature within the range from −1 to −12° C., where the salt concentration and set temperatures of the salt-controlled and temperature controlled solution brings the homogenous temperature of the food product to a value in the range from −0.1 to −3° C., and preferably within the range −0.5 to −3° C., such as about −1° C., or about −1.5° C.

Thereafter, removing the product from the solution and placing in a ice-free or ice reduced package while maintaining the temperature of the product and storing the product in the ice-free or ice reduced package within a space which is maintained at a temperature within the range of about −4° to 0° C.

In the above mentioned first under-cooling step (i) the salt content of the solution is preferably in the range 1-5%, such as in a range from about 1% or from about 1.5% or from about 2%, to about 5%, or to about 4% or to about 3.5%, such as a salt content of about 1.5%, or about 2% or about 2.5% or about 3%. The solution is maintained at a temperature within a range from about +1° C. but preferably from about 0° C. , and more preferably from about −0.5° C., such as from about −1° C. such as from about −1.5° C., to about −3° C. , such as to about −2.5° C. such as to about −2° C. In some embodiments the food product is cooled in this first under-cooling step for a period of time within the range from about 10 minutes, but more preferably from about 15 minutes such as from about 20 minutes or from about 25 minutes or from about 30 minutes, to about 75 minutes, or to about 65 minutes or to about 60 minutes or to about 55 minutes or to about 50 minutes or to about 45 minutes, such as for about 30 minutes or for about 40 minutes or for about 45 minutes or for about 50 minutes or for about 60 minutes.

In the second cooling step the salt concentration is preferably within a range from about 1%, such as from about 2% such as from about 3% such as from about 4% or from about 5%, to about 20%, or to about 15% or to about 12% such as to about 10% such as to about 8% or to about 7%, such as a salt content of about 5%, or about 6% or about 7% or about 8%. The solution is preferably maintained at a temperature within a range from about −1° C. but preferably from about −1.5° C. , and more preferably from about −2° C., such as from about −2.5° C. such as from about −3° C., to about −12° C. , such as to about −10° C. such as to about −8° C., such as to about −7° C. such as to about −6° C., such as a temperature of about −2° C., or about −3° C., or about −4° C. In some embodiments the food product is cooled in the second under-cooling step for a period of time within the range from about 6 minutes, but more preferably from about 8 minutes such as from about 10 minutes or from about 12 minutes or from about 15 minutes, to about 45 minutes, or to about 35 minutes or to about 30 minutes or to about 25 minutes or to about 20 minutes or to about 15 minutes, such as for about 10 minutes or for about 15 minutes or for about 20 minutes or for about 50 minutes or for about 60 minutes.

In one specific embodiment of the present invention a method is provided for reducing the environmental footprint comprising a water footprint and a carbon footprint of a food product. The method comprises a) undercooling the product by submerging in salt solution at a sub-zero temperature at or above the freezing point of the solution, while the solution is agitated in order to prevent formation of ice shell or crust on the product, b) removing the product from the solution and placing in a ice-free package while maintaining the temperature of the product, c) storing the product in the ice-free package within a space which is maintained at a temperature within the range of about −4° to 0° C. Optionally the method comprises step d) of transporting the product in the ice-free package within a space which is maintained at a temperature within the range of about −4° to 0° C.

### DESCRIPTION OF THE INVENTION

In the present context the term “under-cooling” or “sub-chilling” refers to the process or method of bringing fish to a desired temperature at or near the phase transition of freezing the fish without freezing the fish, and generally below the freezing point of water (0° C.). Furthermore, these terms refer to a fish or fish product being brought to or kept at a desired temperature at or near the phase transition of freezing the fish without freezing the fish, such as a temperature below 0° C. (sub-zero conditions), such as preferably at or below −0.2° C., or more preferably at or below −0.5° C., or at or below −0.7° C., or at or below −0.8° C., such as at or below −1.0° C., such as at or below −1.5° C.

In the present context the terms “wet food product”, “food product” or “product” are used equally and relate to a food product selected from freshly slaughtered fish, freshly slaughtered chicken, beef, pork and lamb meat products.

In the present context the term “fish” or “whole fish” relates to a fish which is either freshly caught and unprocessed at all or cut and/or bled and/or gutted and/or washed and/or graded and/or de-headed and/or the tail has been removed or any combination thereof.

In the present context the terms “storing receptacle” or “package” refers to any means of storing and/or transporting food product, such as but not limited to tubs or bulk containers for transporting fish, trays, plastic or cardboard boxes . . . .

In the present context the term “ice reduced or ice-free manner” refers to the placement of “under-cooled” or “sub-chilled” wet food product in a “storing receptacle” in a facility where the surrounding temperature is at least below 0° C., where no additional cooling media is required in the storing receptacle to keep the wet food product at a desired temperature. The term “ice reduced manner” refers to a way of storing and transporting such food products where a small amount if ice is distributed in the storage container f.ex. as a reference that the food products were kept below 0° C.

Carbon footprint (CO2e) is defined herein as the release of all greenhouse gases calculated to CO2 during the steps of production and processing of the raw materials, manufacture and packaging of the food product and logistics relating to all these steps. Thus the carbon footprint includes CO2e from all the steps of the life cycle until the product is available to the consumer.

Water footprint is defined herein as consumption of freshwater resources during all the same steps as mentioned above until the product is put on sale to the consumer.

The carbon and water footprints may be referred to as environmental footprints.

In an embodiment of the present invention the product is fish selected from salmon, trout, cod, haddock, pollock, catfish, ling, blue ling, tusk, monkfish, carp, bass, bream, turbot, sea bass, sole, milkfish, grey mullet, grouper, sea bream, halibut, flounder, Japanese flounder.

In an embodiment of the present invention the fish is gutted and/or bled prior to the step of undercooling.

In an embodiment of the present invention the salt concentration and set temperatures of the salt-controlled and temperature controlled solution(s) for each step in the pre-cooling and under-cooling are based on the type of meat or species of fish, size and fat content of the fish being brought to an under-cooled state.

In an embodiment of the present invention the time for each step in under-cooling is based on the species, size, as well as the fat content of the fish and the quantity of the fish being cooled. In one embodiment, freshly caught cod, slaughtered, gutted and bled is first cooled for 40-50 minutes at a set temperature of −1° C. in a solution of 3% salt concentration and then transferred to a solution of 7% salt concentration set at a temperature of −3° C. preferably for about 15 minutes. Salmon has more fat content, so slaughtered, gutted and bled salmon of same size is in one embodiment cooled for 60 minutes at a set temperature of −1° C. in a solution of 3% salt concentration and then transferred to a solution of 8% salt concentration set at a temperature of −4.5° C. for 25 minutes.

In an embodiment of the present invention the food product is further transported in the ice-free or ice reduced package within a space which is maintained at a temperature within the range of about −4° to 0° C.

In an embodiment of the present invention the food product is undercooled in step a) until the product has reached a homogenous temperature within a range from about −3° C. to about −0.1° C., and preferably within the range from about −2° C. to about −0.1° C.

In an embodiment of the present invention a continuous movement or agitating of the wet food product in the salt solution is provided during the step of bringing the wet food product to an under-cooled state to prevent the surface of the wet food product from freezing and to prevent the formation of shell or crust at the surface of it during the cooling process. The continuous movement of the wet food product in the solution speeds up the cooling process and allows the use of a cooling solution at a warmer temperature, such as close to the target temperature at a certain cooling step.

In an embodiment of the present invention the wet food product is maintained at a temperature above freezing point of the wet food product, but at or near the phase transition temperature of freezing the wet food product without freezing it, such as at a temperature in the range from between about −0.5 to about −2° C. during storing, transfer and processing, such as at about −0.5° C., about −1° C., or about −1.5° C.

In an embodiment of the present invention the temperature of the salt solution is maintained at a temperature which is at least about 1,0° C. higher than the freezing point of the solution, and preferably at least about 1.5° C. higher.

In an embodiment of the present invention the wet food product is brought to a homogenous temperature in the range between −0.2 and −4.0° C., such as a temperature in the range from about −0.5° C., such as from about −0.8° C., such as from about −1.0° C. or from about −1.2° C., to about −4.0° C., or to about −3.5° C., such to about −3.0° C., or to about −2.5° C. In the present context the term “homogenous temperature” refers to equalised average temperature which is measured from 0 to 120 minutes after a cooling process.

In an embodiment of the present invention the packaging comprises a double-layered box of a material in thin layers.

In an embodiment of the present invention the double-layered box is configured and folded so as not to leak liquid while in upright position. In a specific embodiment of the present invention the double-layered box is a double-layered cardboard box.

In an embodiment of the present invention the space in step c) is maintained at a temperature within the range from about −0.5 to about −2° C.

In an embodiment of the present invention the temperature range of the space in steps c) and d) is the main source of maintaining the temperature of the food product below freezing.

In an embodiment of the present invention a small amount of ice or liquid is placed in the storing receptacle.

In an embodiment of the present invention the period of storing and/or transporting the wet food products within a space which is maintained at a temperature within the range of about −4° to 0° C. is from 1 hour to 7 days, such as from 12 hrs to 5 days, or from about 1 day to 3 days, or from about 2 to 6 days.

### EXAMPLES

### Example 1

### Analysis of the Difference Between Sub-Chilling and Traditional Chilling of Salmon

Salmon was taken just after slaughtering and chilled either by using ice (traditional) or by the sub-chilling method of the present invention. The sub-chilled salmon was chilled in a screw-container for 1 hr in a two-step process, where it was first brought into a solution with a temperature of −1° C. and then further to −4° C. Thereafter the salmon was stored at −1.5° for 4 days. The salmon receiving traditional treatment was chilled on ice for 4 days in EPS boxes. Further processing of Salmon 4 days after slaughtering showed that the fish was easy to process and had a good resistance to heading and filleting processes resulting in higher yield (Fig not shown)

Table 1 shows the temperature of the fillets after 2, 4 and 6 days as well as softness and gaping.

TABLE 1

| | Days | | | | | |
|---|---|---|---|---|---|---|
| | 2 | | 4 | | 6 | |
| | Sub | Tradi- | Sub | Tradi- | Sub | Tradi- |
| | Chilled | tional | Chilled | tional | Chilled | tional |
| Temp° C. | −1.5 | 0 | −1.5 | 1 | −1.5 | 0.2 |
| Softness | 0 | 1 | 0 | 1 | 0 | 2 |
| Gaping | 0 | 2 | 0 | 3 | 0 | 4 |
| Rigor | yes | No | Yes | No | No | No |

The results show that the sub-chilled salmon maintains a homogenous temperature of −1.5° C., whereas the traditionally chilled salmon reaches higher temperature, becomes softer and shows increased gaping. The traditionally chilled salmon also starts to get softer, whereas the sub-chilled salmon maintains stiffness.

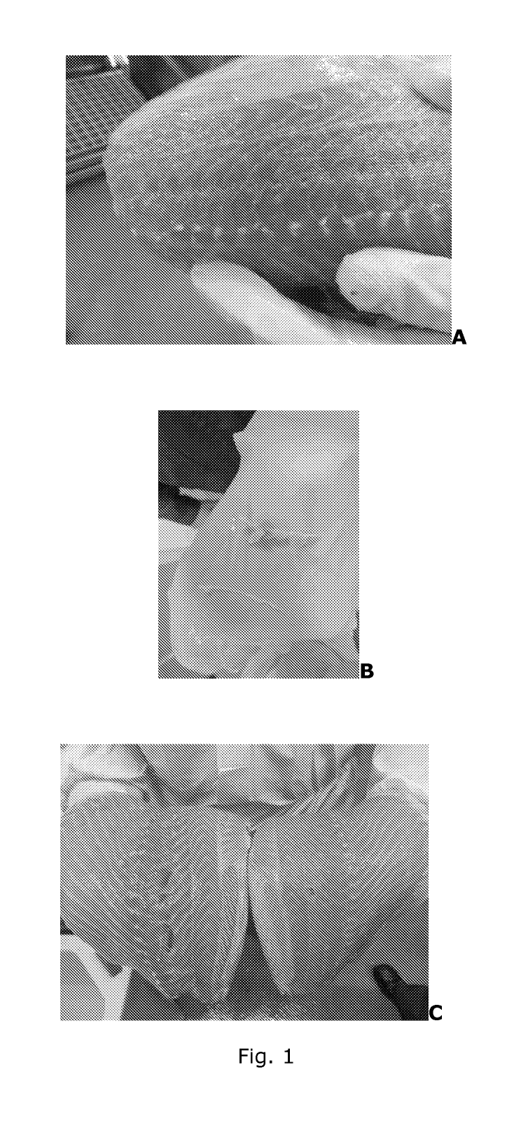

FIG. 1 shows pin bone removal while salmon is in rigor and how pin bones car be removed without damaging fillet. FIG. 1A shows a salmon fillet after pin bone removal. The fillet looks fine and undamaged. FIG. 1B shows two bones, on top a bone removed from a salmon after traditional chilling and below a bone removed from a salmon after sub-chilling. No flesh is attached to the bone from the salmon chilled with sub-chilling, but flesh is attached to the salmon bone chilled with traditional chilling. FIG. 1C shows a comparison of two fillets after pin bone removal. On the left is a fillet, which was chilled by traditional chilling and on the right is a fillet chilled by sub-chilling. The fillet chilled by traditional chilling is damaged after the bin bone removal, whereas the fillet chilled by sub-chilling has very little damage.

### Example 2

### Product Shelf Life of Salmon with Sub-Chilling and Traditional Chilling

Product shelf life of the salmon was also examined based on the chilling method. Table 2 shows bacterial count comparison between salmons chilled by traditional vs. the sub-chilling method.

TABLE 2

| | Total count | | Black colonies/g | |
|---|---|---|---|---|
| Days | Sub-Chilled | Traditional | Sub-Chilled | Traditional |
| 2 | <10.000 | 20.000 | <10.000 | <10.000 |
| 6 | <10.000 | <10.000 | <10.000 | <10.000 |
| 10 | 20.000 | <10.000 | <10.000 | <10.000 |
| 16 | 20.000 | 300.000 | <10.000 | 30.000 |
| 21 | 2.100.000 | 39.000.000 | 20.000 | 910.000 |

The results show that the sub-chilling method extends shelf life dramatically.

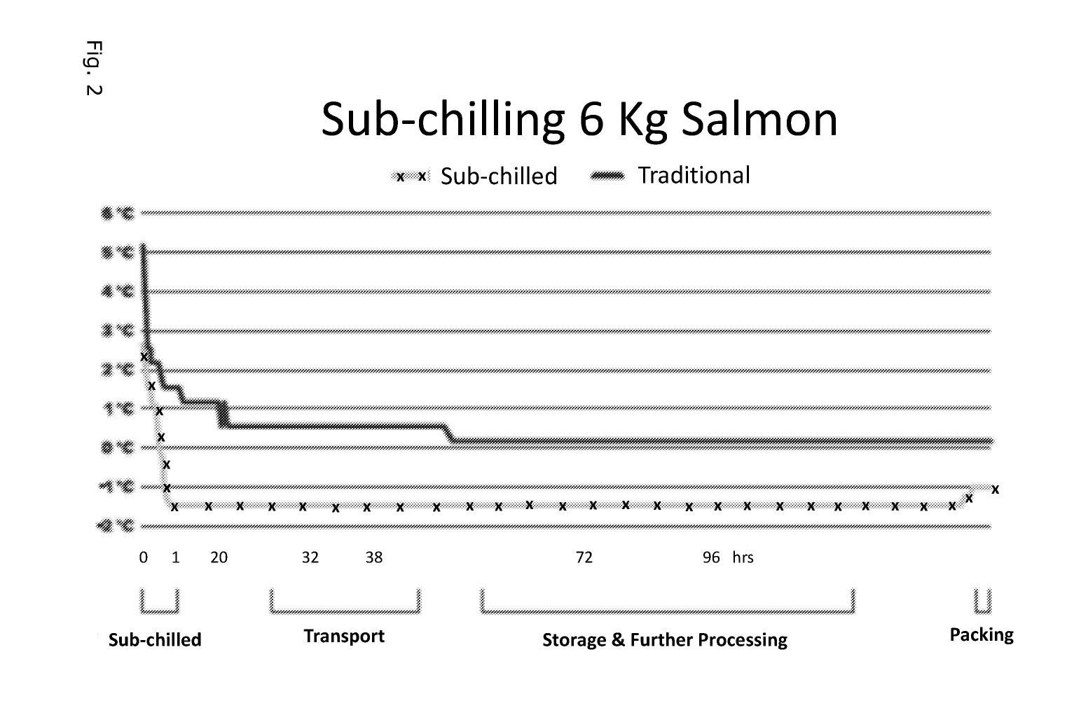

FIG. 2 shows temperature monitoring during transport and processing of salmon chilled by traditional method and sub-chilling method. Sub chilled salmon maintains a temperature of −1.5° C. The temperature of the fish remains stable and the Salmon is in Rigor the whole throughout the process. The traditionally chilled salmon never enters sub-zero conditions and takes longer to cool down.

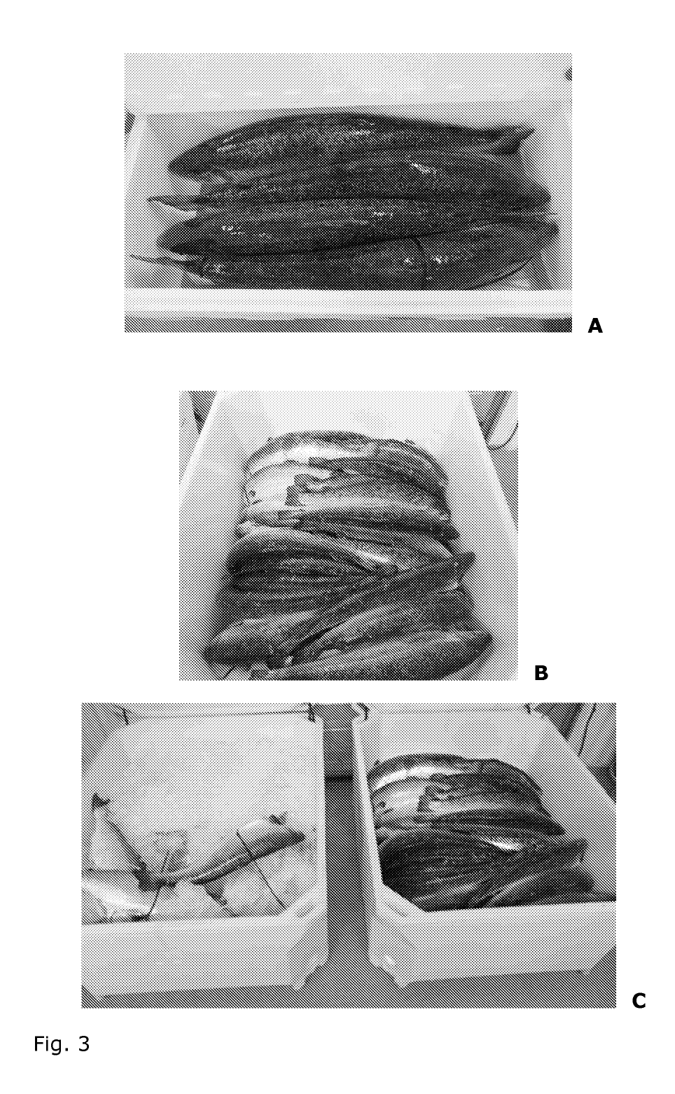

FIG. 3 shows different ways of packing freshly slaughtered gutted fish. FIG. 3A shows whole salmon packed in a Styrofoam box which needs to be filled with ice to keep the product cold. FIG. 3B shows on the left traditional packing for transport in a tub with ice and on the right salmon chilled by the method of the present invention and packed in an ice-free manner in a tub.

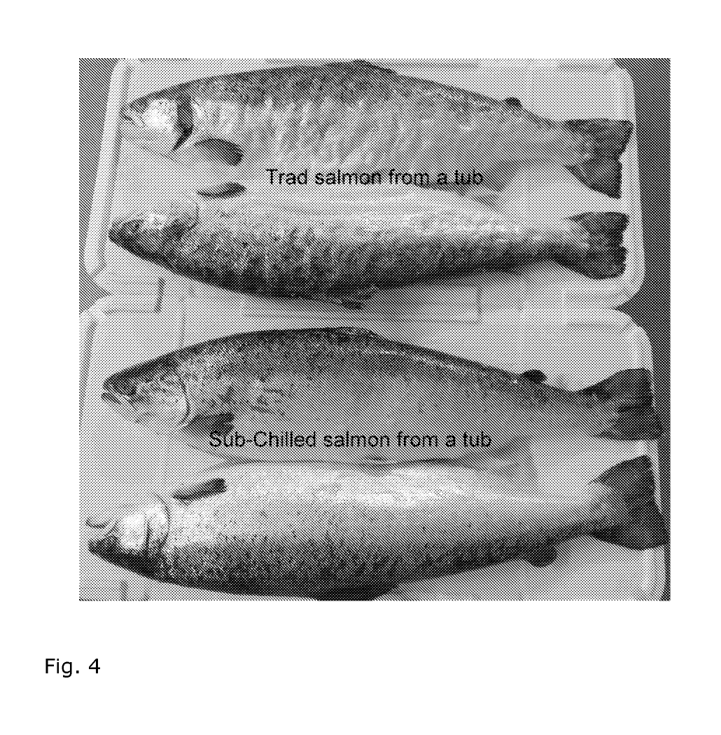

FIG. 4 shows what the salmon looks like after having been packed and transported on ice in a tub (above) and what the salmon looks like after being cooled, packed and transported according to the present invention with under-cooling and ice-free transport in a tub. The salmon transported by the present method has no pressure damage because of the ice in the tub and the fish is stronger.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention can be made while still falling within scope of the invention. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

1. A method of cooling and storing and wet food product, comprising:
a) undercooling the product by submerging in salt solution at a sub-zero temperature at or above the freezing point of the solution, while the solution is agitated in order to prevent formation of ice shell or crust on the product,
b) removing the product from the solution and placing in storing receptacle,
c) storing the product in the storing receptacle within a space which is maintained at a temperature within the range of about −4° to 0° C.

2. The method of claim 1, wherein the method further comprises step d) of transporting the wet food product in the storing receptacle within a space which is maintained at a temperature within the range of about −4° to 0° C.

3. The method of claim 1, wherein the wet food product is undercooled in step a) until the product has reached a homogenous temperature within a range from about −3° C. to about −0.1 ° C., and preferably within the range from about −2° C. to about −0.1 ° C.

4. The method according to claim 1, wherein the undercooling step is performed in a salt-controlled and temperature-controlled solution in at least two steps of:
i) placing the wet food product in first salt-controlled and temperature controlled solution having a salt concentration in the range from 0.1 to 10% and a temperature in the range from +1 to −3° C., where the salt concentration and set temperatures of the salt-controlled and temperature controlled solution brings the homogenous temperature of the fish to +2 to −1° C., and
ii) transferring the wet food product to a second salt-controlled and temperature controlled solution having a salt concentration in the range from 1 to 20% and a temperature in the range from −1 to −12° C., where the salt concentration and set temperatures of the salt-controlled and temperature controlled solution brings the homogenous temperature of the fish to −0.1 to −3° C.

5. The method according to claim 4, wherein the temperature of the solution is maintained at a temperature which is at least about 1.0° C. higher than the freezing point of the solution, and preferably at least about 1.5° C. higher.

6. The method of claim 1, wherein the product is selected from freshly slaughtered fish, freshly slaughtered chicken, beef, pork and lamb meat products.

7. The method of claim 6, wherein the product is fish selected from salmon, trout, cod, haddock, pollock, catfish, ling, blue ling, tusk, monkfish, carp, bass, bream, turbot, sea bass, sole, milkfish, grey mullet, grouper, sea bream, halibut, flounder, Japanese flounder.

8. The method according to claim 4, wherein the fish has been gutted and/or bled prior to the step of undercooling.

9. The method of claim 1, wherein said packaging comprises a double-layered box of a material in thin layers.

10. The method of claim 1, wherein said double-layered box is configured and folded so as not to leak liquid while in upright position.

11. The method of claim 1, wherein said space in step c) is maintained at a temperature within the range from about −0.5 to about −2° C.

12. The method of claim 1, wherein the temperature range of the space in steps c) and d) is the main source of maintaining the temperature of the food product below freezing.

13. The method according to claim 1, wherein a small amount of ice or liquid is placed in the storing receptacle.

14. The method of claim 1, wherein the period of storing and/or transporting the wet food products within a space which is maintained at a temperature within the range of about −4° to 0° C. is from 1 hour to 7 days.

15. A method of reducing the environmental footprint comprising a water footprint and a carbon footprint of a wet food product comprising:
a) undercooling the wet product by submerging in salt solution at a sub-zero temperature at or above the freezing point of the solution, while the solution is agitated in order to prevent formation of ice shell or crust on the product,
b) removing the product from the solution and placing in a storing receptacle,
c) storing the product in the storing receptacle within a space which is maintained at a temperature within the range of about −4° to 0° C., and
d) transporting the product in the storing receptacle within a space which is maintained at a temperature within the range of about −4° to 0° C.
